(19) United States
(12) Patent Application Publication
(10) Pub. No.: US 2006/0099978 A1
(43) Pub. Date: May 11, 2006

(54) Wireless communication terminal with function of confiirming receiver's identity by displaying image corresponding to the receiver and method thereof

(76) Inventors: Byung-Tae Kim, Seoul (KR); Seon-Young Son, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/224,694

(22) Filed: Sep. 12, 2005

(30) Foreign Application Priority Data
Sep. 13, 2004 (KR) 10-2004-0073129

(51) Int. Cl. H04Q 7/20

(52) U.S. Cl. 455/466; 455/566

(57) ABSTRACT

A wireless communication terminal having a function of confirming a receiver by searching an image when editing a message and a method thereof are disclosed. The wireless communication terminal includes: an input unit for receiving a message transmitting request signal, a telephone number and a message; a storing unit for storing an address book where a plurality of images is registered according to a telephone number and the plurality of images; a controlling unit for searching an image corresponding to a telephone number received through the inputting unit by using the address book in response to the message transmitting request signal, reading the searched image from the storing unit, and outputting the read image as a background image of a message editing screen; and an outputting unit for outputting a screen for inputting a telephone number of a receiver, and outputting the read image as the background image.

### CROSS-REFERENCE TO RELATED APPLICATION

The present invention claims the foreign priority to to Korean Patent Application No. KR 2004-0078477, filed in the Korean Intellectual Property Office on Feb. 10, 2004, which is hereby incorporated herein in its entirety.

### FIELD OF THE INVENTION

The present invention relates to a wireless communication terminal having a function of confirming a receiver's identity and a method for confirming the receiver's identity.

### DEFINITIONS

A wireless communication terminal denotes a portable terminal capable of transmitting and receiving data through a wireless communication link. For example, the wireless communication terminal may include a mobile communication terminal, a personal communication service (PCS) terminal, a personal digital assistance (PDA), a smart phone, a terminal for international mobile telecommunication (IMT)-2000 and a wireless local area network (LAN) terminal.

An image denotes a visual display on a display screen. An image includes not only a still image but also moving images. Also, various types of images such as pictures, characters and avatars may be registered or stored in the wireless communication terminal according to the present invention.

A message includes information or data to be delivered to a person or a machine. A message may include text and/or multimedia data, which includes sound and an image. For example, a message includes a short-message created with text for a short-message service (SMS) and a multimedia message created with text and multimedia data including images and/or sound for a multimedia message service (MMS). The short-message is used as an example to explain an embodiment of the present invention.

Generally, a short-message service (SMS) is a supplementary service provided to users of wireless communication terminals. The users exchange a short-message less than 80 Kbytes each others through wireless communication terminals without requiring additional equipments. According to high prevalence of the wireless communication terminal, the SMS has become one of the most popular services used by many users in certain countries. Since the short-message reaches to a correspondent user instantly after transmitting the short-message, the SMS has been used for various purposes.

### DESCRIPTION OF RELATED TECHNOLOGY

Hereinafter, a conventional method of creating a short-message and transmitting the created short-message in a wireless communication terminal will be explained with reference to FIG. 1. FIG. 1 is a flowchart showing a conventional method of creating and transmitting a short-message using a wireless communication terminal.

Referring to FIG. 1, a user inputs a request signal for transmitting a short-message to a wireless communication terminal through an input unit and the wireless communication terminal displays a message editing screen as an interface for a user to input text of a short-message.

After a user inputs the short-message text, a telephone number of a receiver (recipient) and an originator's telephone number are input to the wireless communication terminal at steps S101, S102, and S103.

When a user activates a key for transmitting the short-message, the wireless communication terminal transmits the short-message created in step S101 to the receiver's telephone number input in step S102.

The step for inputting telephone numbers of the receiver and the originator may be performed before or after a step for creating the short-message. For example, telephone numbers of the originator and the receiver input before inputting text of the short-message. After inputting the telephone number, the short-message is transmitted to the receiver by activating a key for transmitting the short-message.

However, the short-messages are often transmitted to an unwanted receiver when a wrong telephone number is input.

### SUMMARY OF CERTAIN INVENTIVE ASPECT OF THE INVENTION

One aspect of the present invention provides a wireless communication terminal having a function of confirming a receiver through an image searching by searching a storing unit to find an image corresponding to a receiver's telephone number input from a user using an address book stored in the wireless terminal and outputting the searched image as a background image of a message editing screen when a message is created in order to easily identify a receiver of a message and reduce false transmission of messages by wrongly inputting a telephone number.

In accordance with an aspect of the present invention, there is provided a wireless communication terminal having a function for confirming a receiver through an image searching when a message is created, the wireless communication terminal including: an inputting unit for receiving a menu selection signal including a message transmitting request signal, a telephone number of a receiver and a message; a storing unit for storing an address book where a plurality of images is registered according to a telephone number and the plurality of images registered in the address book; a controlling unit for searching the storing unit to find an image corresponding to a telephone number received through the inputting unit by using the address book in response to the message transmitting request signal input through the inputting unit, reading the searched image from the storing unit, and outputting the read image as a background image of a message editing screen; and an outputting unit for outputting a screen for inputting a telephone number of a receiver, and outputting the read image as the background image of the message editing screen.

In accordance with another aspect of the present invention, there is provided a method of confirming a receiver of a message when creating a message in a wireless communication terminal, the method including the steps of: a) registering an image corresponding to a telephone number in an address book; b) inputting a telephone number of a receiver where a message is transmitted to; c) searching an storing unit of the wireless communication terminal for finding an image corresponding the input telephone number using the address book and reading the searched image; d) outputting the read image as a background image of a message editing screen; and e) inputting a message and transmitting the input message to the telephone number of the receiver.

### BRIEF DESCRIPTION OF THE DRAWINGS

The above and other features of the present invention will become better understood with regard to the following description of certain embodiments with reference to the accompanying drawings, in which:

FIG. 1 is a flowchart showing a conventional method of creating and transmitting a short-message using a wireless communication terminal;

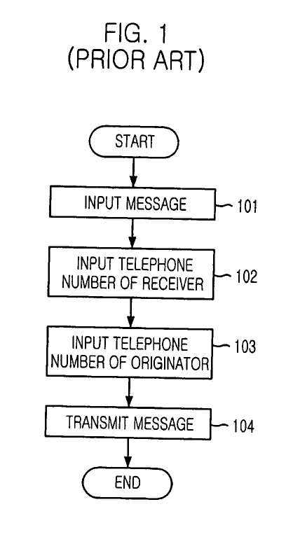

FIG. 2 is a block diagram illustrating a wireless communication terminal having a function for confirming a receiver of a message through an image searching in accordance with an embodiment of the present invention;

FIG. 3 is a flowchart showing a method of confirming a receiver through an image searching when a message is created in a wireless communication terminal according to an embodiment of the present invention; and

FIG. 4 is a view for explaining a method of confirming a receiver through an image searching when a message is created in a wireless communication terminal according to an embodiment of the present invention.

### DETAILED DESCRIPTION OF EMBODIMENTS OF THE INVENTION

In one embodiment of the invention, a wireless communication terminal includes a function of confirming a receiver's identity by searching an image remind the user of the receiver prior to transmitting a message to the receiver or calling the receiver.

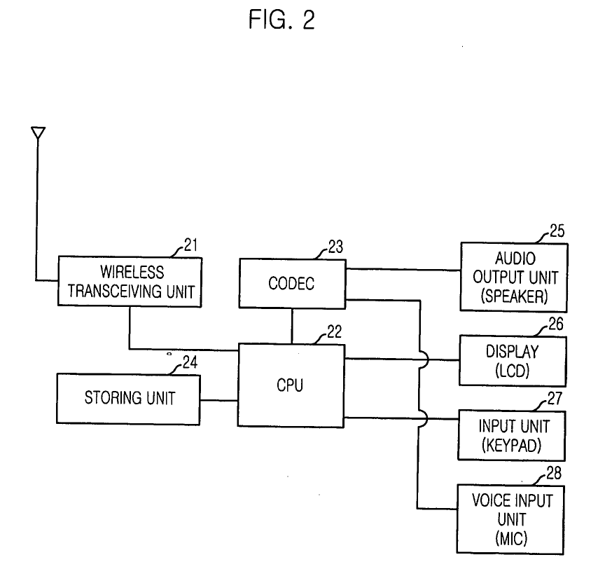

FIG. 2 is a block diagram illustrating a wireless communication terminal having a function for confirming a receiver of a message through an image searching in accordance with an embodiment of the present invention.

Referring to FIG. 2, the wireless communication terminal includes a wireless transceiving unit 21, a central processing unit (CPU) 22, a CODEC 23, a storing unit 24, an audio output unit such as a speaker 25, a display unit such as liquid crystal display (LCD) 26, an input unit such as a keypad 27 and a voice input unit such as mic 28.

The wireless transceiving unit 21 transmits and receives signals through a wireless communication link using an antenna.

The central processing unit (CPU) 22 generally drives and controls the wireless communication terminal. The CPU 22 receives a short-message transmitting request signal from a user through the input unit 27, searches the storing unit to find an image corresponding to a telephone number of a receiver input through the input unit 27 using an address book stored in the wireless communication terminal, and reads the searched image from the storing unit 24. The CPU 22 outputs the read image as a background image of a message editing screen and receives text of a short-message through the input unit 27 from a user. Also, the CPU transmits the short-message to the receiver's telephone number.

If there is no corresponding image stored in the storing unit, a default background image is outputted. For example, the default background image may be a white plane image.

If there is an image corresponding to the telephone number in the storing unit, brightness or transparency of the image are controlled for clearly showing the image to the user when a message is created or edited.

The CODEC 23 converts a signal transferred from the wireless transceiving unit 21 to a voice in response to a control of the CPU 22 and outputs the voice to the audio output unit 25. The CODEC 23 also converts voices input from the audio input unit 28 to a signal and transfers the signal to the CPU 22. The signal is transmitted through the wireless transceiving unit 21.

The storing unit 24 stores programs such as a code, a firmware for driving the wireless communication terminal, an address book where a name, a telephone number, an image and an e-mail address are registered, and images registered at the address book. The images may be photos, pictures, characters, avatars, moving pictures. The images have been previously registered at the address book according to the name or the telephone number.

The audio output unit 25 outputs the voice transferred from the CODEC 23 and the audio input unit 28 receives the voice and transfers the voice to the CODEC 23.

The display unit 26 outputs various screens for displaying a receiver's telephone number or a short-message editing screen in response to a control of the CPU 22.

The input unit 27 receives a menu selection signal including a short-message transmitting request signal, a receiver's telephone number and a short-message using a plurality of buttons prepared on the input unit 27.

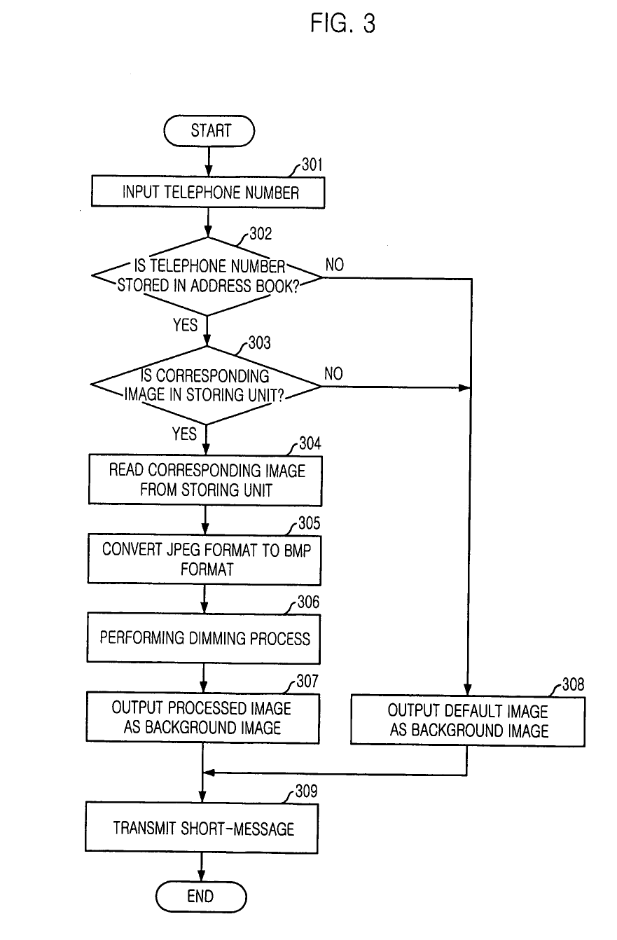

Hereinafter, a method of confirming a receiver by searching an image when editing a message in a wireless communication terminal will be explained with reference to FIG. 3.

FIG. 3 is a flowchart showing a method of confirming a receiver through an image searching when a message is created in a wireless communication terminal according to an embodiment of the present invention.

An address book is previously set up in the wireless communication terminal. The address book contains names, telephone numbers, images and e-mail addresses of one or more potential recipients of messages and/or calls from the user of the terminal. In addition, one or more images may be registered in connection with a telephone number or name of the potential recipients. As described above, the image(s) may be photos, pictures, avatars, characters, moving pictures or any other data that can be visually displayed on a screen.

The CPU 22 of the wireless communication terminal receives a telephone number or a name of a receiver input through the input unit 27 such as a keypad when the wireless communication terminal receives a short-message transmitting request signal from the user at step S301.

The CPU determines whether the received telephone number or name is in the address book at step S302. If the received telephone number or name is not in the address book, a default image is outputted for a short-message editing screen at step S308.

If the received telephone number or name is stored in the address book at step S302, it determined whether a corresponding image is registered at step S303.

If no image is registered corresponding to the telephone number at step S303, the default image is outputted for a short-message editing screen at step S308.

If it is found that a corresponding image is registered at step S303, the corresponding image is read or retrieved from the storing unit 24 (a memory) at step S304. Optionally, the format of the image may be converted to another format to facilitate the display, such as a BMP format at step S305. After retrieving the image (optionally, after converting the format of the corresponding image), a dimming process may optionally be performed at step S306. If the read image is a moving image, for example in a MPEG format, the dimming process may optionally be performed to use the moving image as a background image.

In some embodiments, wireless communication terminals store pictures taken by a built-in camera as JPEG format image files. Depending upon the terminals software for displaying images, a format of the picture may need to be converted to a BMP format in order to use the picture as a background image. The BMP format is a graphic file format developed by a Microsoft for users of MS Windows operating system.

In some embodiment, the built-in camera of the wireless communication terminal has a function to convert the JPEG format image to the BMP format image, in which the conversion is carried out by the built-in camera. In other embodiments where the built-in camera does not have a format conversion function, the CPU 22 or another special processor can convert the image to an appropriate format, for example, by using a decoder.

The image can be displayed on a part of a message editing screen, or can be displayed as a background image or an icon image on a message editing screen.

The background image may be too bright and may interfere with user's viewing the message information including text. To avoid or reduce such interference, in some embodiments, a dimming process is performed on the background image to blur the background image.

A similar dimming process may be performed for moving images such as MPEG format images as the background image.

According to a dimming method, some image pixels are replaced with white pixels (or pixels of another appropriate color). For example, every other pixel in a row or column in an image may emit white (or another appropriate) color so that the positions of white pixels are alternating along the row or column. When the row is changed to the next row, the sequence of image pixels and white pixels are changed so that the positions of the white pixels are alternated with respect to neighboring rows.

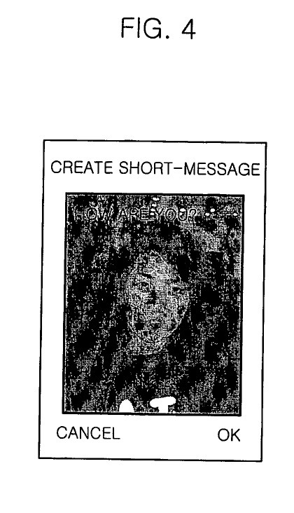

As shown FIG. 4, the processed image is displayed as a background of a text message editing screen at step S307.

In some embodiments, at the step S307, a complementary color of the image can be used in displaying input text for the message, which can help the user read the text displayed with the background image. In one embodiment, the complementary color is obtained by performing an exclusive OR computation on the image color value.

After then, a user activates a key for transmitting a short-message input at step S309 and the wireless communication terminal transmits the short-message to the receiver of the input telephone number (step S301), for example, using the short-message service (SMS).

Furthermore, in some embodiments, the telephone number of an originator may be received before transmitting the short-message at step S309. For example, the telephone number of originator may be received after the step S301 or after at step S307.

As described above, the wireless communication terminal according to an embodiment of the present invention searches the storing unit to find an image corresponding to a telephone number of a receiver input by a user, using an address book and display the searched image as a background image of the short-message editing screen when a short-message is created or edited by a user.

Accordingly, a receiver's identity can be conveniently and easily confirmed before transmitting a message to the receiver, e.g., when creating and editing the short-message. Therefore, the chances of false transmissions of the short-message may be reduced.

While the present invention has been described with respect to certain embodiments, it will be apparent to those skilled in the art that various changes and modifications may be made without departing from the spirit and scope of the invention as defined in the following claims.

What is claimed is:

1. A wireless communication terminal, comprising:
at least one input device configured to receive at least one input of a command to create a message, a command to transmit a message, a phone number, a name and a message content;
a memory configured to store a plurality of names, a plurality of phone numbers and a plurality of images, at least one phone number being associated with one of the names, at least one image being associated with one of the phone numbers and names;
a processor configured to conduct an image search from the plurality of images stored in the memory, wherein when the terminal receives a command to create or transmit a message to a particular phone number or name, the processor conduct a search for an image associated with the particular phone number or name; and
a display device configured to display the image located from the image search.

2. The wireless communication terminal of claim 1, wherein the located image is displayed as part of a message editing screen on the display.

3. The wireless communication terminal of claim 1, wherein the located image is displayed as a background of a message editing screen on the display.

4. The wireless communication terminal of claim 1, wherein the image is displayed as an icon.

5. The wireless communication terminal claim 1, wherein the processor is further configured to process the located image such that the image is displayed in a dimmed-down manner.

6. The wireless communication terminal of claim 5, wherein the display device comprises a plurality of pixels that forms the located image, and wherein at least part of the plurality of pixels emit substantially white light.

7. The wireless communication terminal of claim 1, wherein the display device comprises a plurality of pixels that forms the located image, wherein the display device is further configured to display a text message over the located image displayed thereon, and wherein a pixel that forms the text message has a color which is substantially complementary to a color that the pixel would have generated but for the text message.

8. The wireless communication terminal of claim 1, wherein the at least one input device comprises at least one of a keypad and a voice-recognition system.

9. A method of operating a wireless communication terminal, the method comprising:
providing a wireless communication terminal comprising a memory configured to store a plurality of images;
receiving an input of telephone number or a name of a person, to which a message is transmitted;
searching for an image associated with the telephone number or name from the memory; and
displaying the image associated with the telephone number or name of the recipient on a display screen.

10. The method of claim 9, further comprising receiving an input of the message after displaying the image.

11. The method of claim 9 further comprising receiving an input of the message before the input of the telephone number.

12. The method of claim 9, further comprising transmitting the message to the telephone number.

13. The method of claim 9, further comprising receiving an input of another telephone number or name, and further comprising searching for an image associated with the other telephone number or name.

14. The method of claim 9, wherein the memory stores a plurality of telephone numbers, a plurality of names and a plurality of images, wherein at least one phone number is associated with one of the names, and wherein at least one image is associated with one of the telephone numbers and names.

15. The method of claim 9, further comprising displaying the message on the display screen along with the image associated with the telephone number or name.

16. The method of claim 15, wherein the message is displayed over the displayed image.

17. The method of claim 9, further comprising displaying a default image if no image associated with the telephone number or name of the recipient is located in searching.

18. The method of claim 9, further comprising displaying the message on the display screen along with the image associated with the telephone number or name, wherein the image is displayed as a background of the message.

19. The method of claim 18, wherein the display screen comprises a plurality of pixels that forms the image thereon, and wherein at least part of the pixels emits substantially white light.

20. The method of claim 18, wherein the display device comprises a plurality of pixels forming the located image, wherein the display device is further configured to display a text message over the located image displayed thereon, and wherein a pixel forming the text message has a color which is substantially complementary to a color that the pixel would have displayed but for the text message.
